(19) United States
(12) Patent Application Publication
(10) Pub. No.: US 2022/0338426 A1
(43) Pub. Date: Oct. 27, 2022

(54) Device and Method for Growing Plants Upon an Undulating Surface

(71) Applicant: David G. Ruger, New Paltz, NY (US)

(72) Inventor: David G. Ruger, New Paltz, NY (US)

(21) Appl. No.: 17/540,533

(22) Filed: Dec. 2, 2021

Related U.S. Application Data
(63) Continuation-in-part of application No. 17/242,280, filed on Apr. 27, 2021.

(51) Int. Cl. A01G 13/02

(52) U.S. Cl. CPC A01G 13/0231

(57) ABSTRACT

A device for growing plants above a selected surface includes a bottom member disposed upon a selected surface; a top member disposed upon and secured to said bottom member via two longitudinal securing seams, whereby, said top member includes two outer longitudinal flap portions and a longitudinal center portion, which ultimately receives a growing material in which plants and/or seeds are disposed. The longitudinal flap portions are ultimately folded above the growing material whereby longitudinal edge portions of the flap portions are separated a predetermined distance for allowing water and light to engage the growing material. Pipe members are removably secured to longitudinal edge portions of each longitudinal side of the bottom member, thereby enabling the manual lifting and transport of the device for disposal upon a selected surface.

A modified device for growing plants upon an undulating surface includes the above device with multiple apertures disposed proximate to a selected inner portion of a folded lower flap portion of the top member; and at least one water retaining member disposed between the folded lower flap portion of the top member and a lower elevation side of the bottom member.

This is a Continuation-In-Part Application of Utility application Ser. No. 17/242,280, filed on Apr. 27, 2021.

### BACKGROUND OF THE INVENTION

### 1. Field of the Invention

The present invention generally relates to gardens grown above ground or inside buildings using pots and other containers that allow plant roots to be watered, whereby excess water is drained from the plant roots to a bottom portion of the container thereby preventing root rot.

The present invention provides a device for growing relatively large quantities of plants above a selected surface, including but not limited to soil, wood and concrete. The device includes an elongated section of deformable material that ultimately receives a growing material manually disposed upon a midportion of the deformable material. The device includes pipe members detachably joined to longitudinal sides of the deformable material for stabilizing and lifting the deformable material with the growing material and plants therein. The device further includes a support member that is detachably secured to the pipe members, and a guard member that is detachably secured to the support member, whereby, birds and insects are prevented from engaging the plants and/or seeds disposed in the growing material; and water and sunlight are allowed to engage the plants and/or seeds.

The present invention further provides a device and method for growing plants upon an undulating surface. The method includes determining the slope of an inclined surface selected for growing plants upon; providing an elongated section of deformable material that receives a growing material manually disposed upon a midportion of the deformable material; detachably securing pipe members to opposing sides of the deformable material; and disposing at least one water retaining member between a folded lower elevation flap portion of a top member of the deformable material and a lower elevation pipe member positioned “downhill” from the lower elevation flap portion. The water retaining member includes a lateral dimension corresponding to the slope of the inclined surface. The water retaining member prevents water disposed upon the growing material and escaping via apertures in the top member of the deformable material from flowing downhill and away from the growing material.

### 2. Background of the Prior Art

Prior art flower pots and plant containers are manually lifted and transported to a selected site or surface upon which the pots and/or containers are manually disposed. The pots and containers are manufactured in a variety of sizes and configurations with relatively few plants or seeds inserted into dirt or similar growing material disposed in the containers. Alternatively, plants are inserted in growing materials disposed in relatively large permanent structures connected to or part of a building used as a residence, commercial office or manufacturing facility.

There is a need for a device for growing plants above ground that includes relatively large longitudinal dimensions capable of forming relatively long rows of plants. Further, there is a need for the device to be manually elevated and transported when a growing material containing plants is disposed on the device. There is a need for pipe members of the device to serve as handles and as a support base for orientating deformable members that support growing material with plants. There is a need for the pipe members to detachably receive a support member, which removably receives a guard member for isolating flowers and plants from birds and insects. There is a need for the pipe members and the guard member to be cooperatively coupled for delivering water to the growing material when water is supplied to the pipe members.

There is a need for maintaining water in the growing materials when the device is disposed upon an undulating surface that includes substantially planar and/or inclined surfaces having relatively gradual or steep slopes, or undulating slopes; whereby, each longitudinal and lateral side of the device will engage a ground surface or be disposed proximate to the ground surface, whereby, a growing material disposed upon a top member of the device urges a bottom member of the device to engage a corresponding ground surface irrespective of the slope of the inclined surface that the device is disposed upon.

### SUMMARY OF THE INVENTION

It is an object of the present invention to overcome many of the disadvantages associated with prior art devices for growing plants above a selected surface. A principal object of the present invention is to provide a device that is relatively large and capable of receiving and holding a growing material upon a selected surface. Another principal object of the present invention is to provide a device that ultimately receives multiple seeds and/or plants in the growing material, and that prevents insects and birds from engaging the plants and/or seeds disposed in the growing material. A feature of the device is a top member secured to a bottom member having substantially the same configuration and dimensions as the top member. Another feature of the device is that the top member, after being longitudinally secured to the bottom member, includes two outer longitudinal flap portions and a longitudinal center portion. An advantage of the device is that each of the two outer longitudinal flaps portions and longitudinal center portion have substantially the same configuration and dimensions. Another advantage of the device is that the outer flap portions of the top member are foldable after growing material is disposed upon center portion of the top member, whereby, the growing material is captured within the top member after opposing edge portions of the flap securing portions are detachably secured together. Still another advantage of the device is that the opposing edge portions of the flap securing portions are separated a distance that enables light and moisture to engage the captured and exposed growing material, thereby promoting the growth of the seeds and/or plants.

Another object of the present invention is to provide pipe members are detachably secured to the bottom member of the device. A feature of the device is pipe pouches formed in each longitudinal edge of the bottom member of the device. An advantage of the device is that a pipe member is slidably inserted into each pipe pouch, and slidably removed from each pipe pouch, thereby providing a solid structure for maintaining the longitudinal dimension of the device when a deformably material is used to fabricate the bottom and top members. Another advantage of the device is that the pipe members promote the manual lifting and transport of the device for ultimately disposing the device upon a selected surface.

Still another object of the present invention is to provide a support member that detachably secures to the pipe members after the predetermined plants and/or seeds are disposed in the growing material. A feature of the device is to configure and dimension the support member to detachably receive a guard member. An advantage of the device is that the support and guard members cooperate to prevent insects and birds from engaging the plants and/or seeds disposed in the growing material. Another advantage of the device is that the guard member can be fabricated from materials that allow sunlight and/or moisture to engage the plants and seeds in the growing material.

Yet another object of the present invention is to provide water to the growing material disposed in the top member of the device. A feature of the device is multiple water apertures disposed in the support member, which is fabricated from pipes relatively smaller in diameter than the pipe members, whereby each water aperture directs water into a predetermined area of the growing material. Another feature of the device is connecting the support member to the pipe members, whereby, water supplied to the pipe members, via a single hose, flows through the pipe members and into the support member. An advantage of the device is that water having a relatively low pressure is directed upon the exposed growing material, thereby irrigating the growing material.

Another object of the present invention is to provide equipment for automatically controlling water flow to the growing material. A feature of the device is a combination timer and valve member detachably secured to both a water hose and an end of one of the pipe members. Another feature of the device is a battery for energizing the timer-valve combination when a relatively long time period of water flow is required, and/or the time period of operation must be controlled from the internet. An advantage of the device is that water flow can be controlled when manual oversight is not available.

Still another object of the present invention is to provide a device for growing plants upon inclined surfaces having a relatively “steep” slope. A feature of the device of the present invention is a lower water retaining member, whereby, the lower water retaining member is vertically disposed between a folded lower elevation flap portion of a top member of the device, and a lower elevation pipe member of the device positioned “downhill” from the lower elevation flap portion. Another feature of the device is dimensioning the lower water retaining member, whereby, the lower water retaining member includes a lateral dimension corresponding to the slope of an inclined surface that the device is disposed upon, resulting in a top edge of the lower water retaining member elevated a selected distance above water apertures in a lower portion of the folded lower elevation flap portion of the top member of the device. An advantage of the device is that the lower water retaining member restricts water disposed upon the growing material from escaping the folded lower elevation flap portion water apertures of the top member at a rate that prevents required quantities of water from engaging plant roots; the water apertures being included for preventing water from accumulating around plant roots in relatively large quantities that would damage plant growth.

Yet another object of the present invention is to provide a device for growing plants upon an inclined surface that includes a relatively gradual slope, whereby, water apertures in the lower portion of the folded lower elevation flap portion of the top member of the device have an elevation a relatively short distance below the elevation of water apertures in a lower portion of a folded upper elevation flap portion of the top member of the device. A feature of the device is an upper water retaining member, whereby, the upper water retaining member is vertically disposed between the folded upper elevation flap portion of the top member of the device, and an upper elevation pipe member of the device positioned “uphill” from the upper elevation flap portion. Another feature of the device is dimensioning the upper water retaining member, whereby, the upper water retaining member includes a lateral dimension corresponding to the slope of an inclined surface that the device is disposed upon, resulting in a top edge of the upper retaining member elevated a selected distance above water apertures in a lower portion of the folded upper elevation flap portion of the top member of the device. An advantage of the device is that the upper water retaining member cooperates with the lower water retaining member to prevent water disposed upon the growing material from escaping the folded top elevation flap portion water apertures of the top member at a rate that prevents required quantities of water from engaging plant roots; the water apertures being included for preventing water from accumulating around plant roots in relatively large quantities that would damage plant growth.

Another object of the present invention is to provide a method for growing plants upon surfaces that may vary in slope, whereby, the slope may vary from substantially planar to gradually inclined, and/or to steeply inclined in varying degrees, then back to substantially planar. A feature of the method is that the plants can be irrigated with quantities of water required to grow the plants without damaging the plants via excessive quantities of water. An advantage of the method is that the user can grow and irrigate plants disposed upon a device placed upon a selected ground surface that is substantially perpendicular to the slope of the selected ground surface for growing plants above ground. Another advantage of the method is that the user can grow and irrigate plants disposed upon a device placed upon a selected ground surface that varies from substantially horizontal to substantially inclined with the longitudinal sides of the device being disposed substantially perpendicular to the slope of the selected ground surface, whereby, sufficient quantities of water are supplied to the plant roots to promote the growth of plants irrespective of surface slope. Another advantage of the method is that water is prevented from accumulating (irrespective of the selected ground surface slope) in quantities that would retard or damage plant growth.

### BRIEF DESCRIPTION OF THE DRAWINGS

The foregoing invention and its advantages may be readily appreciated from the following detailed description of the preferred embodiment, when read in conjunction with the accompanying drawings in which:

FIG. 1 is a top perspective view of a device for growing plants above a selected surface with a growing material disposed upon a top member of the device, the top member depicted with folded flap portions securing the position of the growing material in accordance with the present invention.

FIG. 2 is a top perspective view of a top member disposed upon a bottom member of the device.

FIG. 3 is the top perspective view of FIG. 2, but with pipe members disposed proximate to pipe pouches formed in the bottom member.

FIG. 4 is the top perspective view of FIG. 1, but without flap portions of the top member folded over growing material.

FIG. 5 is the top perspective view of FIG. 1, but with a net material covering the support structure and the top member.

FIG. 6 is a side view of the cross-arm portion of FIG. 1.

FIG. 7 is a right-side view of the cross-arm portion of FIG. 6.

FIG. 8 is the top perspective view of the device of FIG. 1, but with the device modified by adding upper and lower water retaining members in accordance with the present invention.

FIG. 9 is a top plan view of portions of the aforementioned device disposed between portions of two modified devices all longitudinally aligned upon a ground surface having corresponding sloped portions and a substantially horizontal portion in accordance with the present invention.

FIG. 9A is a profile view of the ground surface of FIG. 8 but with the slopes offset from a linear orientation whereby the portions of the aforementioned device and modified devices are depicted on corresponding slopes in accordance with the present invention.

FIG. 10 is the top perspective view of the modified device of FIG. 8, but with the support and guard members removed.

FIG. 11 is an end elevation view of FIG. 10 disposed on inclined slope 6 depicted in FIG. 8.

FIG. 12 is the top perspective view of a top member disposed upon a bottom member of the modified device with guard members and upper and lower water retaining members removed.

FIG. 13 is the top perspective view of the modified device of FIG. 11, but with the support and guard members included in accordance with the present invention.

FIG. 14 is the top perspective view of FIG. 11, but with the pipe members separated from the bottom member.

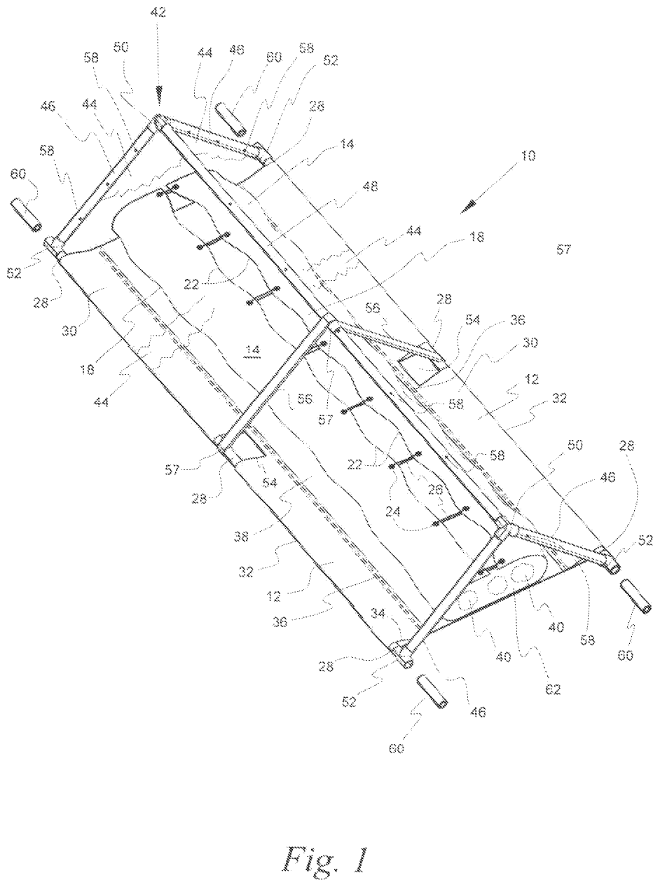

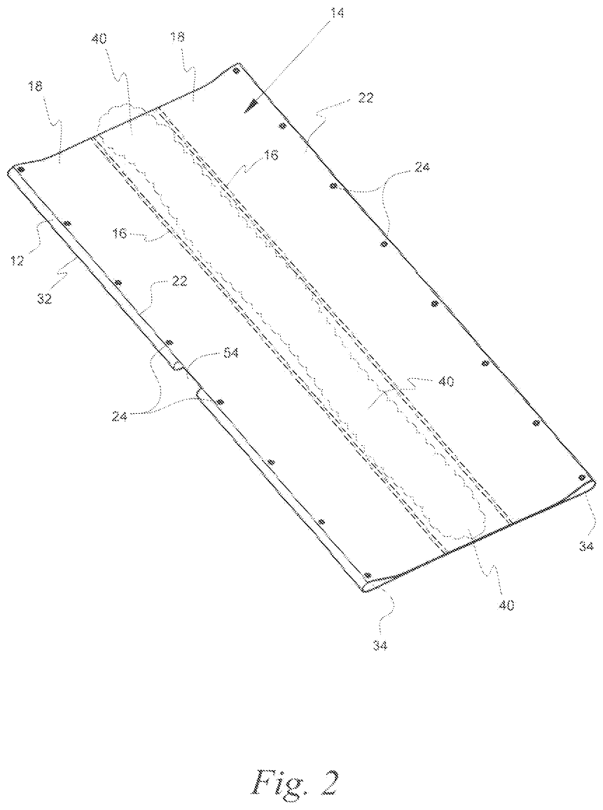

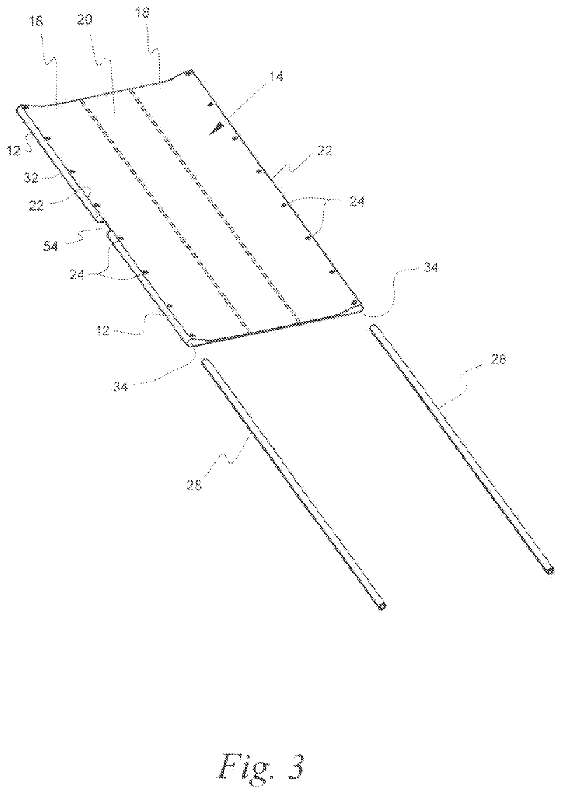

### DESCRIPTION OF THE PREFERRED EMBODIMENT

Referring to the figures, a device for growing plants above a selected surface (not depicted) inside a structure or outside and exposed to the elements is denoted by numeral 10. The device 10 includes a bottom member 12 disposed upon a preselected surface (not depicted); a top member 14 disposed upon and secured to said bottom member 12 via two longitudinal securing seams 16 or lines of relatively strong twine, resulting in a top member 14 having two outer longitudinal flap portions 18 and a longitudinal center portion 20. Each of the two outer longitudinal flap portions 18 and longitudinal center portion 20 have substantially the same configuration and dimensions. The two outer longitudinal flap portions 18 are foldable for disposal above the longitudinal center portion 20, whereby, longitudinal edge portions 22 of the two outer longitudinal flap portions 18 are ultimately disposed above the longitudinal center portion; whereby, the longitudinal edge portions 22 are substantially parallel and separated a predetermined distance for allowing water and light to engage the growing material that contains preselected seeds and/or plants.

The bottom and top members 12 and 14 can be fabricated from a myriad of materials, including but not limited to polymers and canvas, but porous landscaping fabric having a relatively high tensile strength that resists tearing (well known to those of ordinary skill in the art) is the preferred material. The edge portions 22 of the flap portions 18 include a plurality of longitudinally aligned apertures 24 disposed proximate to each longitudinal edge portion 22. Flap securing members 26 for detachably securing together the longitudinal edge portions 22 of the longitudinal flap portions 18 via the apertures 24 can be fabricated from a myriad of materials including but not limited to leather, rubber, nylon and similar materials slightly “stretchable,” resistant to changes in weather and with a tensile strength capable of maintaining the proximate positions of the flap portions 18 when relatively heavy plants and growing materials 40 (not part of the invention) are disposed upon the top member 14. Reinforcing rings (not depicted, but well known to those of ordinary skill) can be inserted into the apertures 24 for preventing the tearing of the longitudinal edge portions 22 of the flap portions 18 of the top member 14 when the flap securing members 26 detachably secure the longitudinal edge portions 18 together via the apertures 24.

The preferred distance separating adjacent apertures 24 in an edge portion 22 of a flap portion 18 is substantially twelve inches. The preferred distance separating cooperating apertures 24 in opposite edge portions 22 of the flap portions 18 is substantially six inches after the flap securing members 26 forcibly draw the edge portions 22 together, whereby, the open area between adjacent flap securing members 26 promotes the manual insertion of plants and/or seeds into the growing material 40. Alternatively, the plants and/or seeds can be disposed in the growing material 40 before the edge portions 22 of the flap portions 18 are forcibly drawn together by the flap securing members 26; however, the positioning of the plants and/or seeds in the growing material 40 must be between adjacent apertures 24 in an edge portion 22 of a flap portion 18, thereby preventing engagement between the flap securing members 26 and respective plants.

A pipe member 28 is removably secured to each longitudinal edge portion 30 of each longitudinal side 32 of the bottom member 12 by sliding the pipe member 28 into a pipe pouch 34 formed in the edge portion 30 by a single or double stitch of a relatively high tensile strength string 36 securing the edge portion 30 upon an inner portion 38 of the bottom member 12. The pipe member 28 promotes the manual lifting and transport of the device for disposal upon a selected surface.

A growing material 40 (not part of the device 10) such as a combination of black dirt and fertilizer, which promote the growth of the predetermined plants and/or seeds, is ultimately disposed upon the longitudinal center portion 20 of the top member 14; whereupon, the predetermined plants and/or seeds are disposed in the growing material 40. A support member 42 is detachably secured to the pipe members 28 after the predetermined plants and/or seeds are disposed in the growing material 40. The support member 42 is configured and dimensioned to detachably receive a guard member 44; whereby, the support member 42 and the guard member 44 cooperate to prevent insects and birds from engaging the plants and/or seeds disposed in the growing material 40. The support member 42 can be fabricated from steel or polymer pipe having a diameter of about one-half inch. The length of the pipe is dependent upon the longitudinal dimension of the device 10. The guard member 44 can be fabricated from weather resistant netting material, tempered glass or “greenhouse glass,” but greenhouse plastic is the preferred material for preventing access to the plants and seed by insects and birds; however, the greenhouse plastic allows sunlight to engage the plants, but the netting reduces the sunlight that ultimately engages the plants.

The support member 42 includes at least two inverted, substantially “V” configured opposing pipe sections 46 that are end portions of the support member 42. The pipe sections 46 are joined together at the apex of the inverted V configuration via a lineal pipe section 48 and cooperating offset “T” configured fittings 50. The two V configured pipe sections 46 are detachably joined to each pipe member 28 via two cooperating offset “T” configured fittings 52, thereby detachably securing the support member 42 to the pipe members 28. The elevation of the lineal pipe section 48 is about two feet above the top member 14.

In the event that the distance separating the V pipe sections 46 of the support member 42 causes the guard member 44 to “sag,” pipe pouch apertures 54 can be provided in the pipe pouches 34 to sufficiently expose the pipe members 28 for allowing a cooperating “C” configured clamping end of a respective cross arm portion 56 of the support member 42 to engage a respective pipe member 28. Opposite “C” configured clamping ends 57 of the cross-arm portions 56 engage the lineal pipe 48. The clamping ends 57 of the cross-arm portions 56 detachably secure to the aperture 54 exposed pipe members 28, and can also be detachably secured to a cooperating section of the lineal pipe 48. The cross-arm portions 56 reduce the distance or gap between the V configured pipe sections 46, and correspondingly reduces the sag of the guard member 44.

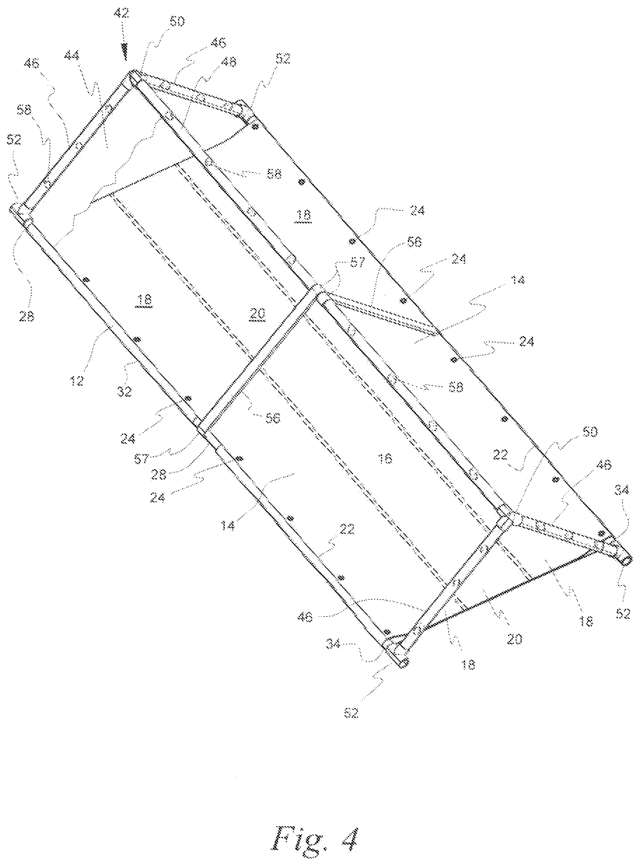

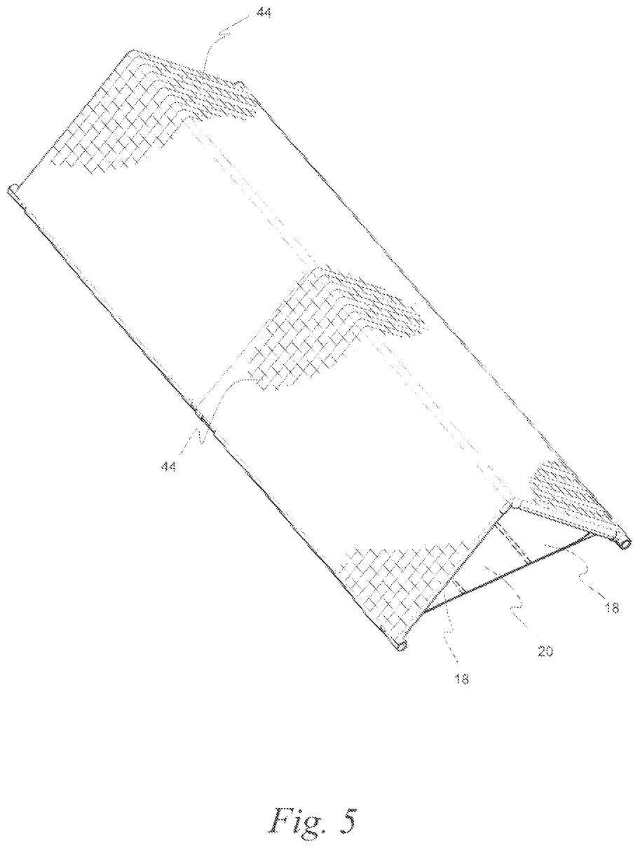

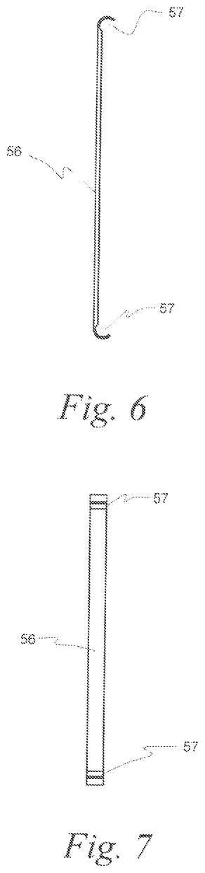

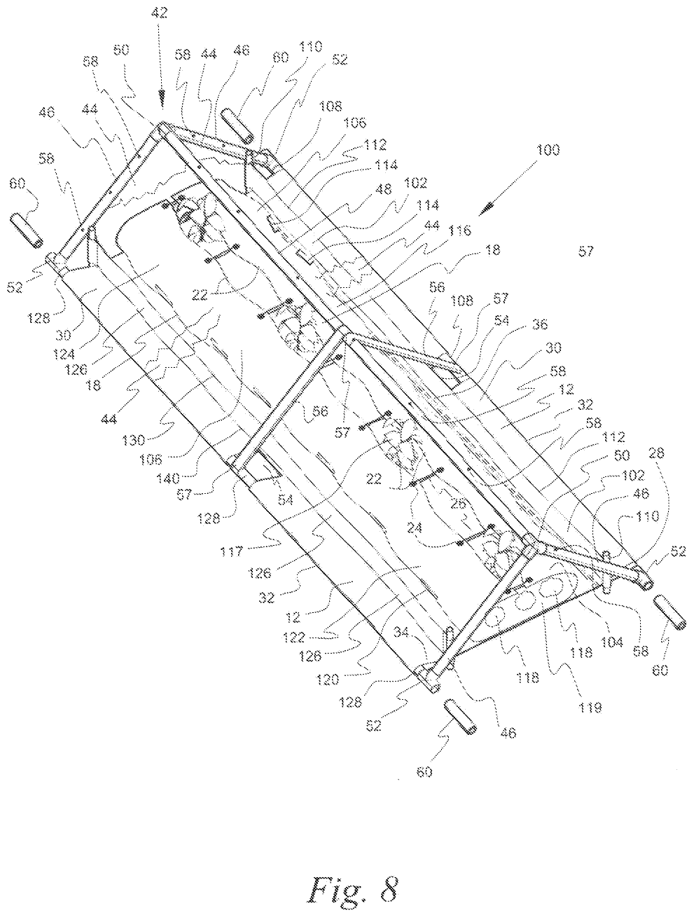

Referring to FIG. 4, to moisturize the growing material 40, the two V configured pipe sections 46 and the lineal pipe section 48 of the support member 42 can include multiple water apertures 58 that direct water (having a relatively small pressure) in a generally downward direction upon the exposed growing material 40. Alternatively, water apertures 58 can be included with only the V configured pipe sections 46 or only the lineal pipe section 48. Irrespective of the location of the apertures 58 in the pipe sections 46 and 48, the apertures 58 “aim” water to intersect the longitudinal centerline of the center portion 20 of the top member 14, whereby, low water flow moistures the growing material 40 without damaging the plants in growing material 40. In the event that excessive water should flow from the openings 62 in the opposing ends formed by the folded flap portions 18 of the top member 14, a relatively small section of non-porous material (not depicted) can be stappled to a lower portion of the openings 62, whereby, a wall is formed that either prevents or restricts water flow from the folded top member 14.

In the event that the pipe members 28 need to be lengthened to promote the manual grasping of the pipe members 28 when lifting the device 10, lifting handles 60 can be added to the T fittings 52 via a pipe having a relatively short longitudinal dimension. The lifting handles 60 can be threaded to detachably receive cooperating pipe members 28 of a duplicate device 10 (the preferred longitudinal dimension for the device 10 is ten feet), thereby doubling the longitudinal dimension of the resulting device 10 to twenty feet.

In the event that the device 10 must irrigate the growing material 40 without manual oversight, a combination timer and valve member (not depicted) can be detachably secured to both a pressurized water hose (not depicted) and an end of one of the pipe members 28, thereby allowing water to flow through the water apertures 58 and upon selected portions of the growing material 40 for a predetermined time period. The combination timer and valve member can include a battery (not depicted) to power the combination when a relatively long time period of water flow is required, and/or the time period of operation must be controlled from the internet.

In operation, a user of the device 10 selects a site having a surface that the device is to be disposed upon. The surface can be inside a structure, or outside and exposed to the elements. After selecting the site and surface, the user configures and dimensions the device 10 to cooperate with the dimensions of the surface. The dimensions and configuration for the device 10 are determined by the user, but the dimensions and configuration preferred by the inventor are substantially ten feet by three feet with a rectangular configuration; however, the longitudinal dimension of the device 10 can vary from three feet to a length greater than ten feet by detachably securing together multiple ten feet sections to ultimately form a lineal row of the detachably secured sections. When the lateral dimension of the selected surface is greater than about seven feet, multiple parallel rows of the device 10 can be configured from multiple ten feet sections.

Assuming that the selected surface includes a longitudinal dimension of twenty-five feet and a lateral dimension of five feet, two devices 10 for growing plants above the selected surface could be disposed upon the surface, whereby, the two devices 10 are longitudinally joined or are separated at the discretion of the user. Each device 10 would be formed by disposing ten feet by three feet congruently secured together bottom and top members 12 and 14, whereby, only two outer longitudinal flap portions 18 and a longitudinal center portion 20 of the top member 14 are exposed. Each flap portion 18 and the longitudinal center portion 20 have a lateral dimension of substantially one foot.

A pipe member 28 slightly longer than ten feet is removably secured to each longitudinal edge portion 30 of each longitudinal side 32 of the bottom member 12 by sliding the pipe member 28 into a ten feet pipe pouch 34 formed in the edge portion 30 by a single or double stitch of a relatively high tensile strength string 36 that secures the edge portion 30 upon an inner portion 38 of the bottom member 12. The exposed ends of the pipe member 28 promote the manual lifting and transport of the device for disposal upon or from a selected surface. Alternatively, relatively short sections of pipe can be rotationally secured to the pipe members 28 to form extended handles 60 for the users.

After assembling the bottom and top members 12 and 14, and the pipe members 28, a preselected growing material 40 is disposed upon the center portion 20 in quantities that allow the two outer longitudinal flap portions 18 of the top member 14 to fold above the growing material 40, whereby, longitudinal edge portions 22 of the flap portions 18 are detachably joined, whereby, the flap portions 18 are substantially parallel and separated a predetermined distance for allowing water and light to engage the growing material 40 that contains manually added seeds and/or plants.

A support member 42 is detachably secured to the pipe members 28 after the predetermined plants and/or seeds are disposed in the growing material 40. The support member 42 is configured and dimensioned to detachably receive a guard member 44; whereby, the support member 42 and the guard member 44 cooperate to prevent insects and birds from engaging the plants and/or seeds. The guard member 44 includes cross arm portions 56 for added support for the guard member 44 in the event that the guard member “sags” between V configured pipe sections 46, and correspondingly reduces the sag of the guard member 44. The support member 42 may include multiple apertures 58 for irrigation and/or fertilizing the ground material 40 and the seeds and/or plants in the ground material 40. Water hoses (not depicted) would ultimately be detachably joined to the pipe members 28 to provide water to the support member 42, whereby, water would flow from support apertures 58 and would be directed only upon predetermined portions of the growing material 40. Water is allowed to escape a non-porous the top member 14 via end openings 62 formed via folded flap portions 18. In the event that the user needs to prevent or restrict water flow via the end openings 62, a relatively small sections of non-porous material can be stappled to a lower portion of the openings 62, whereby, a wall is formed that either prevents or restricts water flow from the folded top member 14.

The user can elevate the device 10 via handles 60 and transport and ultimately dispose one or multiple devices 10 upon the selected surface, whereby, the device 10 or multiple joined devices 10 are arranged upon the selected surface to promote growth of the seeds and/or plants in the growing material 40.

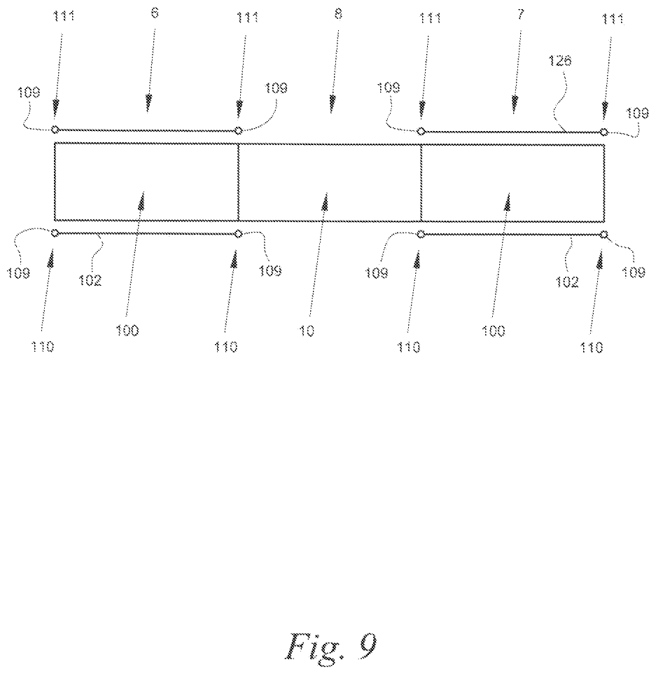

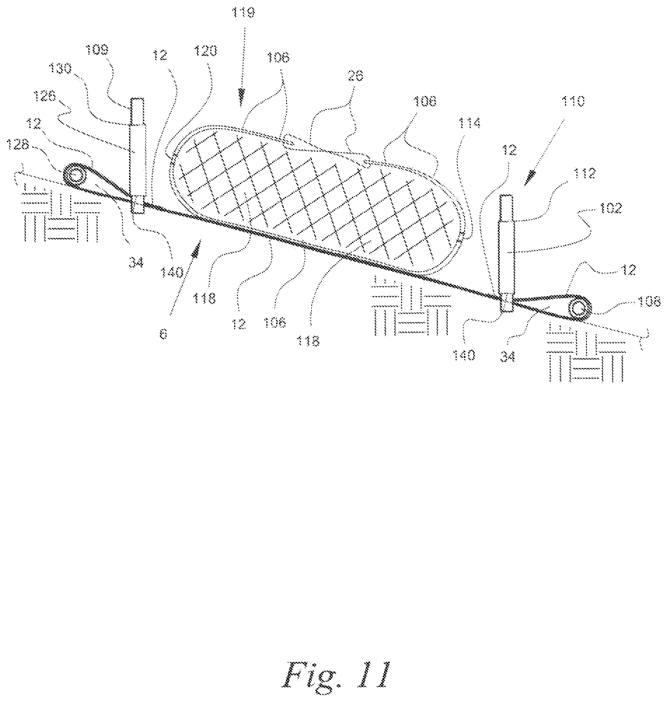

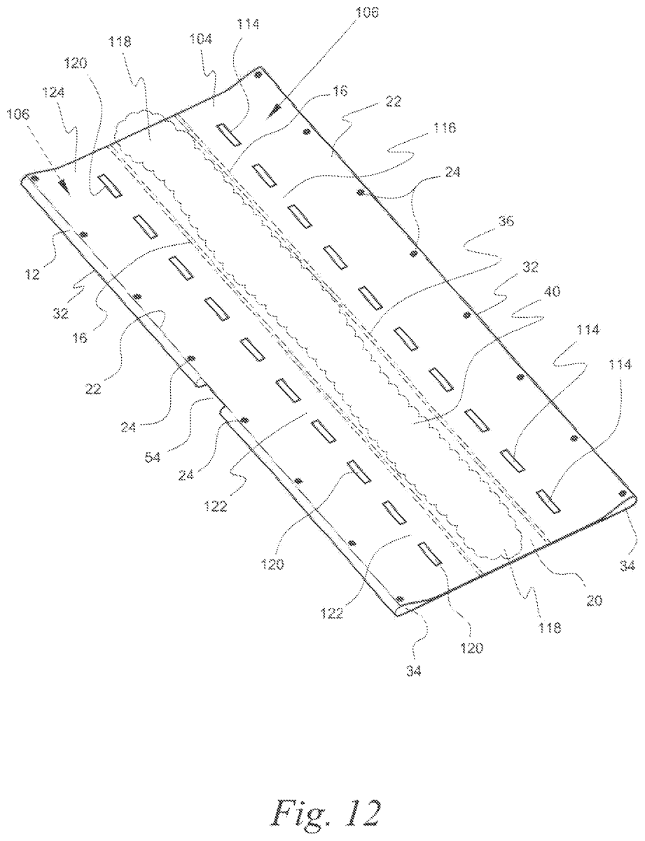

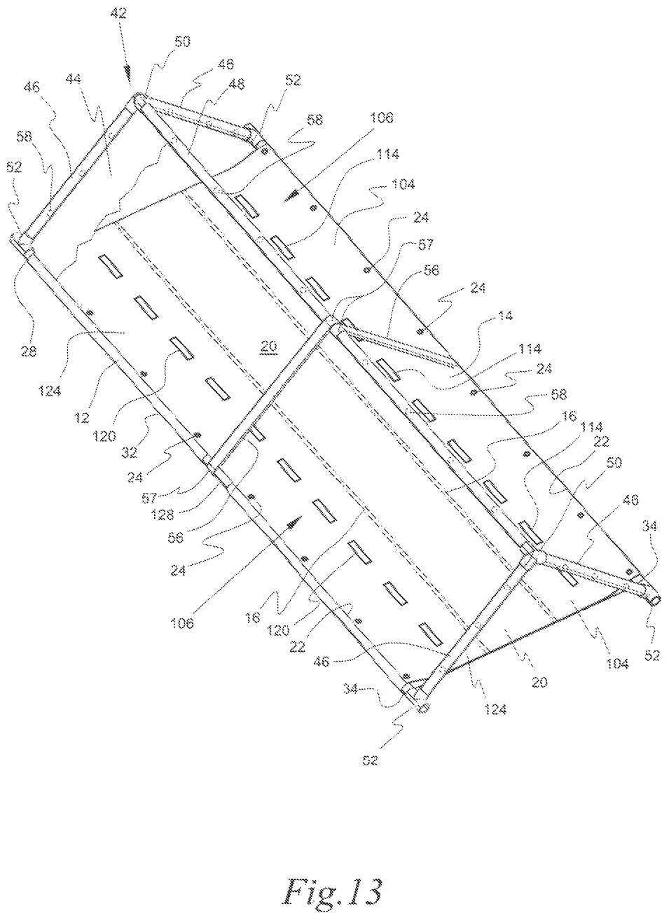

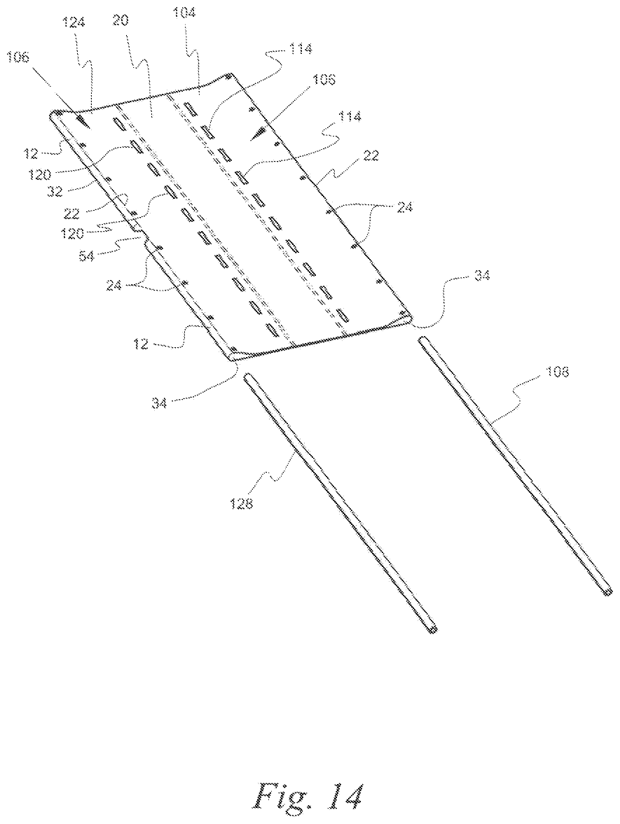

Referring now to FIGS. 8-13, a modified device for growing plants above a selected inclined surface 6 and 7 in accordance with the present invention is denoted by numeral 100. The modified device 100 is fabricated from the same materials as the aforementioned device 10. An alternative material of fabrication for the modified device 100 is a porous landscaping fabric having a relatively high tensile strength that resists tearing but can be penetrated by a wooden or steel stake or post (well known to those of ordinary skill in the art) is the preferred material. The aforementioned device 10 used to grow plants on a substantially planar horizontal surface 8 (see FIG. 8), and the modified device 100 for growing plants upon an inclined surface 6 and 7 (FIG. 8), provide a user a method for growing plants upon surfaces that may undulate and vary in slope, whereby, the slope may vary from substantially planar 8 to relatively “steep” angles 6 and 7 depicting opposing slopes, then back to substantially planar. The device 100 enables the user to irrigate plants disposed upon either the device 10 for growing plants upon a horizontal surface, or the device 100 for growing plants 117 upon an inclined surface; whereby, sufficient quantities of water are supplied to the plant roots to promote the growth of plants 117, but the method also enables the user to prevent water from accumulating around plant roots in relatively large quantities that would damage plant 117 growth. As an alternative to using both devices 10 and 100, the modified device 100 could be used on a horizontal surface 8 to retain a water level on the surface 8 via water retaining members 102 and 126.

The modified device 100 includes a lower water retaining member 102 vertically disposed between a folded lower elevation flap portion 104 of a top member 106 of the device 100, and a lower elevation side 32 of the bottom member 12 of the device 100 positioned “downhill” from the lower elevation flap portion 104. The top member 106 is disposed upon and secured to the bottom member 12 via two longitudinal securing seams 16 or lines of relatively strong twine, resulting in the top member 106 having the lower elevation flap portion 104 and an upper elevation flap portion 124 and a longitudinal center portion 20. Each of the two outer longitudinal flap portions 104 and 124, and longitudinal center portion 20 have substantially the same configuration and dimensions. The two outer longitudinal flap portions 104 and 124 are foldable for disposal above the longitudinal center portion 20, whereby, longitudinal edge portions 22 of the two outer longitudinal flap portions 104 and 124 are ultimately disposed above the longitudinal center portion 20; whereby, the longitudinal edge portions 22 are substantially parallel and separated a predetermined distance for allowing water and light to engage a growing material 118 longitudinally encased via the top member 106. The growing material 118 is viewable via open ends 119 of the top member 106, and contains preselected seeds and/or plants 117.

The lower water retaining member 102 includes lateral sides 110 formed via an end portion of the water retaining member 102 disposed about a wooden or metal stake or post 109 manually driven into an exposed ground surface. Alternatively, the stake 109 can be urged through the bottom member 12 and into the ground surface in the event that multiple lower water retaining members 102 having longitudinal dimensions shorter than the longitudinal dimension of the bottom member 12 are used. The lower water retaining member 102 includes a lateral dimension that disposes a top edge 112 of the lower water retaining member 102 a relatively short distance above the elevation of inner or upper water apertures 114 in a lower portion 116 of the folded lower elevation flap portion 104 of the top member 106 of the device 100.

The top edge 112 elevation of the lower water retaining member 102 cooperates with the water apertures 114 elevation to prevent water disposed upon the growing material 118 from escaping the folded lower elevation flap portion water apertures 114 of the top member 106 at a rate that prevents required quantities of water from engaging plant roots (not depicted). The water apertures 114 are included for preventing water from accumulating around plant roots in relatively large quantities that would damage plant 117 growth. The water accumulated from the apertures 114 via the lower water retaining member 102 will eventually flow around the lateral sides 110 of the lower water retaining member 102, thereby lowering the water level below the apertures 114 after the water supply is manually “turned off” or after a rain storm has ceased, and after the plant roots have been sufficiently irrigated.

The modified device 100 further includes water apertures 120 in an inner or lower portion 122 of a folded upper elevation flap portion 124 of the top member 106 of the device 100. An upper water retaining member 126 is vertically disposed between the folded upper elevation flap portion 124 of the top member 106 of the device 100, and an upper elevation side 32 of the bottom member 12 of the device 100 positioned “uphill” from the upper elevation flap portion 124. The lower and upper water retaining members 102 and 126 are fabricated from flexible, non-porous strips of materials capable of retaining water. The apertures 120 in the folded upper elevation flap portion 124 of the top member 106 will have no influence upon the water level resulting from the lower water retaining member 102 until the slope of the ground surface that one or more longitudinally aligned modified devices 100 are disposed upon changes slope direction as depicted in FIG. 8, slopes 6 and 7. The changed slope direction of the ground surface changes the lower water retaining member 102 depicted in slope 6 to the upper water retaining member 102 depicted in slope 7; and correspondingly changes the upper water retaining member 126 depicted in slope 6 to the lower water retaining member 126 depicted in slope 7.

The upper water retaining member 126 includes a lateral dimension corresponding to the slope of an inclined surface that the device 100 is disposed upon, resulting in a top edge 130 of the upper water retaining member 126 elevated a relatively short distance above water apertures 120 in a lower portion 122 of the folded upper elevation flap portion 124 of the top member 106 of the device 100. When the ground slope changes from slope 6 to slope 7 as depicted in FIG. 8, the upper retaining water member 126 on slope 6 is changed to a lower water retaining member 126 depicted in inclined surface or slope 7. The upper water retaining member 126 includes lateral sides 111 having dimension corresponding to the slope of an inclined surface 7 that the device 100 is disposed upon, resulting in a top edge 130 of the upper water retaining member 126 elevated a selected distance above water apertures 120 in a lower portion 124 of the folded upper elevation flap portion 124 of the top member 106 of the device 100.

The top edge 130 elevation of the upper water retaining member 126 cooperates with the water apertures 120 elevation to prevent water disposed upon the growing material 118 from escaping the folded elevation flap portion water apertures 120 of the top member 106 at a rate that prevents required quantities of water from engaging plant roots. The water apertures 120 are included for preventing water from accumulating around plant roots in relatively large quantities that would damage plant growth. The water accumulated from the apertures 120 via the upper water retaining member 126 will eventually flow around the lateral sides 111 of the upper water retaining member 126, thereby lowering the water level below the apertures 120 after the water supply is manually “turned off” or after a rain storm has ceased, and after the plant roots have been sufficiently irrigated.

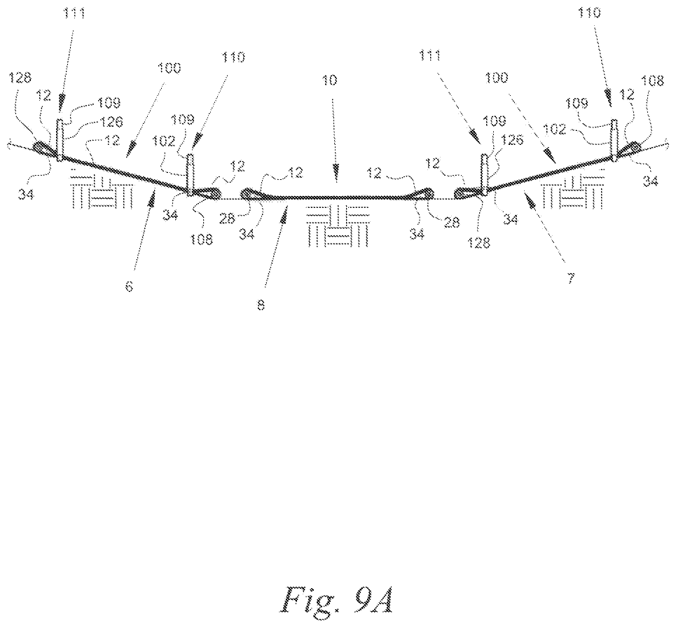

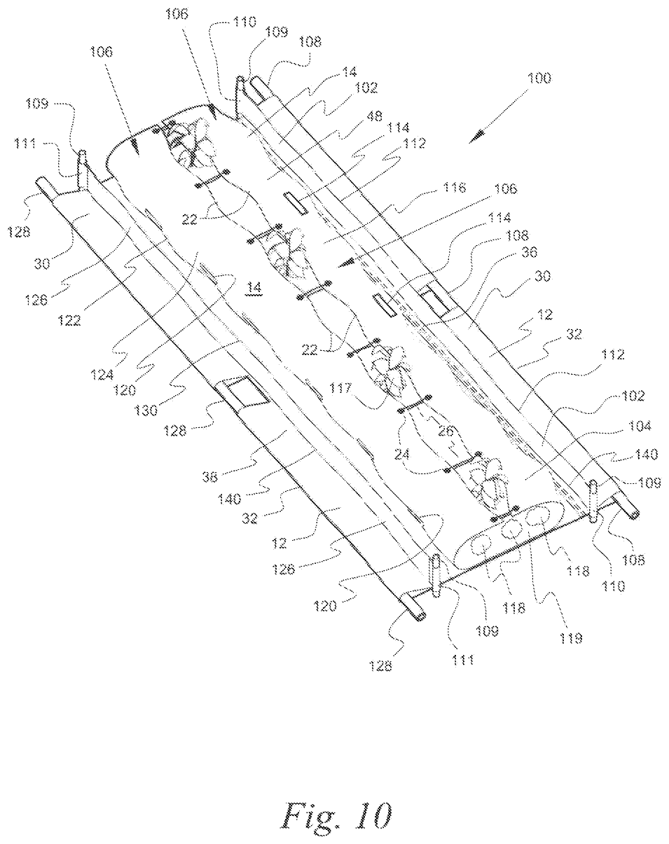

Referring to FIG. 10, an illustration of the modified device 100 is depicted without the support member 42, T fittings 52, and elevation pipe members 108 and 128, thereby reducing the rigidity of the device 100 and enabling one or more modified devices 100 to be longitudinally aligned upon steep undulating surfaces that would not allow the modified device 100 of FIG. 9 to congruently engage the same undulating surfaces. The modified device 100 of FIG. 10 includes the lower and upper retaining water members 102 and 126, thereby enabling the device 100 to maintain sufficient irrigation of the growing material 118 and the plant 117 roots therein. Further, the lower and upper retaining water members 102 and 126 include bottom edges 140 that maintain engagement with selected top surface portions of the bottom member 12 to prevent water from escaping under the bottom edges 140. In the event that the longitudinal dimension of the lower and upper retaining water members 102 and 126 need to be decreased a dimension that enables the water members 102 and 126 to maintain engagement with the bottom member 12, multiple water members 102 and 126 will be required for each bottom member 12. Each water member 102 and 126 will require lateral sides 110 and 111 that detachably receive wooden or metal posts that are manually urged through the bottom member 12 and into the ground surface below.

Both devices 10 and 100 together or only the modified device 100 provide a method for growing plants upon surfaces that may undulate and vary in slope, whereby, the slope may vary from substantially planar to gradually inclined, and/or to steeply inclined in varying degrees, then back to substantially planar. The method enables the user to grow and irrigate plants disposed upon a horizontal surface, or upon inclined surfaces varying in slope from gradual to steep, whereby, sufficient quantities of water are supplied to the plant roots to promote the growth of plants irrespective of surface slope, but the method also prevents water from accumulating around plant roots in relatively large quantities that would retard or damage plant growth irrespective of surface slope.

A method that includes both devices 10 and 100 is described as follows:

selecting a ground surface for receiving multiple devices 10 and/or 100 for growing plants above ground;

selecting a substantially linear path upon the selected ground surface for disposing the multiple devices 10 and 100 for growing plants;

evaluating the selected linear path for planar and sloped portions;

disposing a planar plant growing device 10 upon a substantially horizontal, planar portion of the linear path, the planar plant growing device 10 including:

a bottom member 12 ultimately disposed upon a preselected surface;

a top member 14 disposed upon and secured to said bottom member via two longitudinal securing seams 16, whereby, the top member 14 includes two outer longitudinal flap portions 18 and a longitudinal center portion 20, the longitudinal flap portions 18 being foldable for disposal above the longitudinal center portion 20, whereby, longitudinal edge portions 22 of each longitudinal flap portion 18 are ultimately disposed above the longitudinal center portion 20, whereby the longitudinal edge portions 22 are separated a predetermined distance;

a plurality of apertures 24 disposed proximate to each longitudinal edge portion 22 of the longitudinal flap portions 18 of the 14 top member;

flap securing members 26 for detachably securing together the longitudinal edge portions 22 of the longitudinal flap portions 18 via the apertures 24;

a pipe member 28 secured to a longitudinal edge portion 30 of each longitudinal side 32 of the bottom member 12;

a support member 42 secured to the pipe members 28 after a preselected growing material 40 is disposed on the longitudinal center portion 20 of the top member 14, after predetermined plants and/or seeds are disposed in the growing material 40, and after the longitudinal flap portions 18 are secured together above the longitudinal center portion 20; and

a guard member 44 secured to the support member 42; whereby, the bottom and top members 12 and 14, and the pipe members 28 cooperate to secure the position of the growing material 40 upon a selected surface, and the support member 42 and the guard member cooperate 44 to prevent insects and birds from engaging plants and/or seeds disposed in the growing material 40;

disposing a slope plant growing device 100 upon a sloped portion of the linear path, the slope plant growing device 100 including:

a bottom member 12 ultimately disposed upon a preselected surface;

a top member 106 disposed upon and secured to the bottom member 12 via two longitudinal securing seams 16, whereby, the top member 106 includes an outer longitudinal lower elevation flap portion 104, an outer longitudinal upper elevation flap portion 124 and a longitudinal center portion 20, the longitudinal flap portions 104 and 124 being foldable for disposal above the longitudinal center portion 20, whereby, longitudinal edge portions 22 of each longitudinal flap portion 104 and 124 are ultimately disposed above the longitudinal center portion 20, whereby the longitudinal edge portions 22 are separated a predetermined distance;

a plurality of apertures 24 disposed proximate to each longitudinal edge portion 22 of the longitudinal flap portions 104 and 124 of the top member 106;

a plurality of lineal apertures 114 disposed proximate to a lower portion 116 of a folded lower elevation flap portion 104 of the top member 106 of the device 100;

a plurality of lineal apertures 120 disposed proximate to a lower portion 122 of a folded upper elevation flap portion 124 of the top member 106 of the device 100;

a lower water retaining member 102 vertically disposed between a folded lower elevation flap portion 104 of the top member 106, and a lower elevation pipe member 108 positioned “downhill” from the lower elevation flap portion 104;

an upper water retaining member 126 vertically disposed between the folded upper elevation flap portion 124 of the top member 106, and an upper elevation pipe member 128 positioned “uphill” from the upper elevation flap portion 124;

flap securing members 26 for detachably securing together the longitudinal edge portions 22 of the longitudinal flap portions 104 and 124 via the apertures 24;

securing the lower and upper elevation pipe members 108 and 128 to edge portions 30 of each longitudinal side 32 of the bottom member 12; and

irrigating the growing material 118, whereby the quantity of water engaging plant roots is determined by the position of the upper and lower water retaining members 126 and 102 relative to the plurality of water apertures 114 and 120 in the top member 106 of the device 100.

The foregoing description is for the purpose of illustration only and is not intended to limit the scope of protection accorded this invention. The scope of protection is to be measured by the following claims, which should be interpreted as broadly as the inventive contribution permits.

1. A device for growing plants above a selected inclined surface comprising:
a bottom member ultimately disposed upon a preselected surface;
a top member disposed upon and secured to said bottom member via two longitudinal securing seams, whereby, said top member includes lower and upper flap portions and a longitudinal center portion, said lower and upper flap portions being foldable for disposal above said longitudinal center portion, whereby, longitudinal edge portions of each flap portion are ultimately disposed above said longitudinal center portion, whereby said longitudinal edge portions are separated a predetermined distance;
a plurality of apertures disposed proximate to each longitudinal edge portion of said lower and upper flap portions of said top member;
flap securing members for detachably securing together said longitudinal edge portions of said lower and upper flap portions via said apertures;
multiple apertures disposed proximate to selected inner portions of said folded lower and upper flap portions of said top member;
a lower water retaining member disposed between said folded lower flap portion of said top member and a lower elevation side of said bottom member;
a pipe member secured to a longitudinal edge portion of each longitudinal side of said bottom member;
a support member secured to said pipe members after a preselected growing material is disposed on said longitudinal center portion of said top member, after predetermined plants and/or seeds are disposed in the growing material, and after said longitudinal flap portions are secured together above said longitudinal center portion; and
a guard member secured to said support member; whereby, said bottom and top members, and said pipe members cooperate to secure the position of the growing material upon a selected surface, and said support member and said guard member cooperate to prevent insects and birds from engaging plants and/or seeds disposed in the growing material.

2. The device of claim 1 wherein said device includes an upper water retaining member disposed between said folded upper elevation flap portion of said top member and an upper elevation side of said bottom member.

3. The device of claim 1 wherein said at lower retaining member is vertically disposed.

4. The device of claim 2 wherein said upper water retaining member is vertically disposed.

5. The device of claim 1 wherein said lower retaining member includes sides formed via an end portion of said lower water retaining member disposed about a stake manually driven into an exposed ground surface.

6. The device of claim 1 wherein said upper water retaining member includes sides formed via an end portion of said upper water retaining member detachably secured to a stake manually urged through said bottom member and into a ground surface.

7. The device of claim 1 wherein said lower water retaining member includes a longitudinal dimension greater than a corresponding longitudinal dimension of said bottom member.

8. The device of claim 1 wherein said upper water retaining member includes a longitudinal dimension greater than a corresponding longitudinal dimension of said bottom member.

9. The device of claim 1 wherein said lower water retaining member includes a longitudinal dimension shorter than a corresponding longitudinal dimension of said bottom member.

10. The device of claim 1 wherein said upper water retaining member includes a longitudinal dimension shorter than a corresponding longitudinal dimension of said bottom member.

11. The device of claim 1 wherein multiple lineal apertures are longitudinally disposed proximate to an inner portion of a folded lower elevation flap portion.

12. The device of claim 1 wherein multiple lineal apertures are longitudinally disposed proximate to an inner portion of a folded upper elevation flap portion.

13. The device of claim 1 wherein said at least one water retaining member includes a lateral dimension that disposes a top edge of said at least one water retaining member a relatively short distance above an elevation of water apertures in an inner portion of said folded lower elevation flap portion of said top member.

14. The device of claim 2 wherein said upper water retaining member includes a lateral dimension that disposes a top edge of said at least one water retaining member a relatively short distance above an elevation of water apertures in an inner portion of said folded upper elevation flap portion of said top member.

15. The device of claim 1 wherein said at least one water retaining member and said upper water member include bottom edges that maintain engagement with selected top surface portions of said bottom member for preventing water from escaping under said bottom edges.

16. The device of claim 1 wherein said pipe and support members cooperate to provide water for irrigating the growing material.

17. The device of claim 1 wherein said pipe member promotes the manual positioning of said device upon a selected ground surface; whereupon, said pipe member can be used to irrigate the growing material and can be detached from said bottom member when said pipe member is not required for irrigating the growing material.

18. The device of claim 1 wherein the lower elevation of said at least one water retaining member relative to said upper water member can be varied, whereby, the elevation of said at least one water retaining member is relatively higher than the elevation of said upper water member.

19. A garden device comprising:
a bottom member ultimately disposed upon a preselected surface;
a top member disposed upon and secured to said bottom member via two longitudinal securing seams, whereby, said top member includes two outer longitudinal flap portions and a longitudinal center portion, said longitudinal flap portions being foldable for disposal above said longitudinal center portion, whereby, longitudinal edge portions of each longitudinal flap portions are ultimately disposed above said longitudinal center portion, whereby said longitudinal edge portions are separated a predetermined distance;
a plurality of apertures disposed proximate to each longitudinal edge portion of said longitudinal flap portions of said top member;
flap securing members for detachably securing together said longitudinal edge portions of said longitudinal flap portions via said apertures;
a lower water retaining member vertically disposed between a folded lower elevation flap portion of said top member and a selected side of said bottom member; and
a pipe member secured to a longitudinal edge portion of each longitudinal side of said bottom member, said lower water retaining member being vertically disposed between a folded lower elevation flap portion of said top member and a selected side of said bottom member; whereby, said flap members and said at least one water retaining member cooperate to irrigate a growing material that includes plants and/or seeds, the growing material being disposed upon said longitudinal center portion of said top member.

20. A garden device for growing plants upon a predetermined surface comprising:
a bottom member disposed upon a preselected surface;
a top member disposed upon and secured to said bottom member via two longitudinal securing lines, whereby, said top member includes two outer longitudinal flap portions and a longitudinal center portion, each portion having substantially the same surface area, said longitudinal flap portions being foldable for disposal above said longitudinal center portion, whereby, longitudinal edge portions of said longitudinal flap portions are ultimately disposed above said center portion, whereby said longitudinal edge portions are separated a predetermined distance;
flap securing members for detachably securing together said longitudinal edge portions of said longitudinal flap portions above a growing material disposed upon said center portion; and
at least one water retaining member vertically disposed between a folded lower elevation flap portion of said top member and a selected side of said bottom member; whereby, said flap members and said at least one water retaining member cooperate to irrigate the growing material that includes plants and/or seeds.
